(19) United States
(12) Patent Application Publication
(10) Pub. No.: US 2026/0054412 A1
(43) Pub. Date: Feb. 26, 2026

(54) WOOD PLANER

(71) Applicant: EXTEND LIGHT MACHINERY CO., LTD., Taichung City (TW)

(72) Inventor: SHIH-HSIN CHANG, Taichung City (TW)

(21) Appl. No.: 18/811,864

(22) Filed: Aug. 22, 2024

(51) Int. Cl. B27C 1/12

(52) U.S. Cl. CPC B27C 1/12

(57) ABSTRACT

A wood planer has a base disposed at a bottom of the wood planer to be deployed on a ground, an elevating mount disposed above the base and can be driven to move up and down relative to the base, two drive sets, and two transfer devices respectively disposed at the base and the elevating mount. Each drive set has a motor and multiple redirection devices connected to the motor. Each transfer device includes multiple roller assemblies and multiple universal joints. Each roller assembly has at least one roller. Each universal joint has an output end and an input end opposite in position. The output end of each universal joint is connected to one of the rollers of a corresponding one of the roller assemblies to power the roller to rotate. The input end of each universal joint is connected to a corresponding one of the redirection devices.

### BACKGROUND OF THE INVENTION

### 1. Field of the Invention

The present invention relates to a thickness planer, and more particularly to a wood planer able to plane woods in a wide thickness range.

### 2. Description of Related Art

In order to process wood to form a smooth surface on the wood, a wood planer is configured to trim or to plane the wood by cutters.

A traditional wood planer can only plane one side of the wood. To promote the efficiency of planing, a conventional double-sided wood planer is provided to plane the top side and the bottom side of the wood simultaneously. With reference to FIG. 7, the conventional double-sided wood planer for planing dual sides of the wood usually has a base 60 and an elevating mount 70 that can be driven by an elevating device to move up and down relative to the base 60. The cutters are disposed at both the base 60 and the elevating mount 70 for planing the top and bottom sides of the wood.

In the conventional double-sided wood planer, both the base 60 and the elevating mount 70 have transfer devices such as rollers to move the wood inside the conventional double-sided wood planer. Wherein, the conventional double-sided wood planer drives the transfer devices on the base 60 and the elevating mount 70 by only one motor 80. The power provided by the motor 80 is transmitted to the transfer devices on the base 60 and the elevating mount 70 via a transmitting device 90 with worms and worm gears and via universal joints 100.

However, powering the transfer devices by the sole motor 80 and transmitting the power of the motor 80 via the transmitting device 90 and the universal joints 100 makes each universal joint 100 sweep restrictedly. Thickness range of the woods to be planned by the conventional double-sided wood planer is restricted accordingly.

To overcome the shortcomings of the conventional wood planer, the present invention provides a wood planer to mitigate or obviate the aforementioned problems.

### SUMMARY OF THE INVENTION

The main objective of the present invention is to provide a wood planer that facilitates a wider thickness range for processing.

The wood planer has a base disposed at a bottom of the wood planer to be deployed on a ground, an elevating mount disposed above the base and can be driven to move up and down relative to the base, two drive sets, and two transfer devices respectively disposed at the base and the elevating mount. Each drive set has a motor and multiple redirection devices connected to the motor. Each transfer device includes multiple roller assemblies and multiple universal joints. Each roller assembly has at least one roller. Each universal joint has an output end and an input end opposite in position. The output end of each universal joint is connected to one of said rollers of a corresponding one of the roller assemblies to power the roller to rotate. The input end of each universal joint is connected to a corresponding one of the redirection devices.

Other objects, advantages, and novel features of the invention will become more apparent from the following detailed description when taken in conjunction with the accompanying drawings.

### BRIEF DESCRIPTION OF THE DRAWINGS

FIG. 1 is a partial side view of a wood planer in accordance with the present invention;

FIG. 2 is a partial front view of the wood planer in FIG. 1;

FIG. 3 is a partial perspective view of the wood planer in FIG. 1;

FIG. 4 is an enlarged front view of the wood planer in FIG. 1;

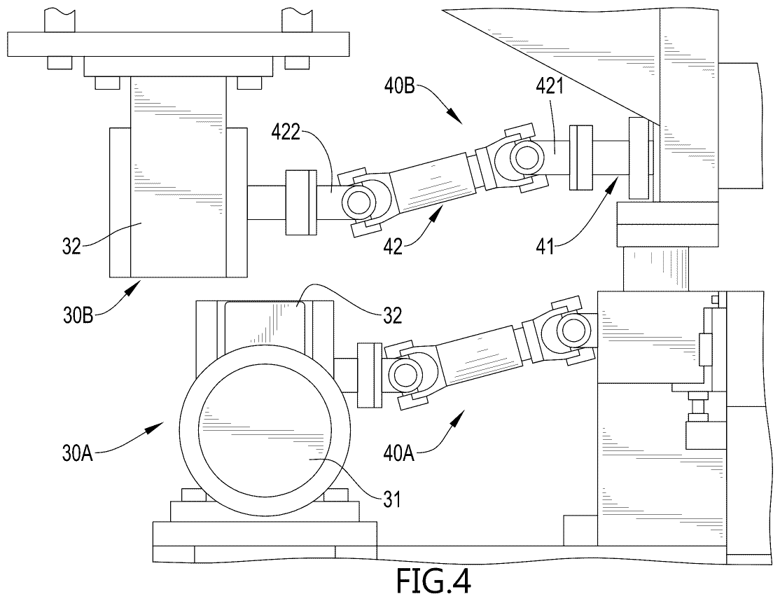

FIG. 5 is an enlarged side view of the wood planer in FIG. 1;

FIG. 6 is a schematic top diagram of the wood planer in FIG. 1; and

FIG. 7 is a partial front view of a conventional double-sided wood planer.

### DETAILED DESCRIPTION OF PREFERRED EMBODIMENTS

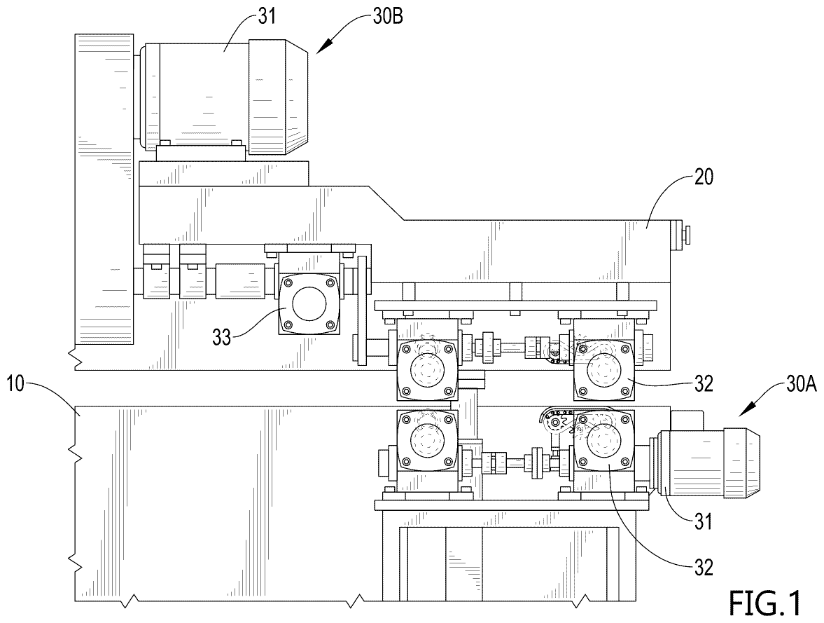

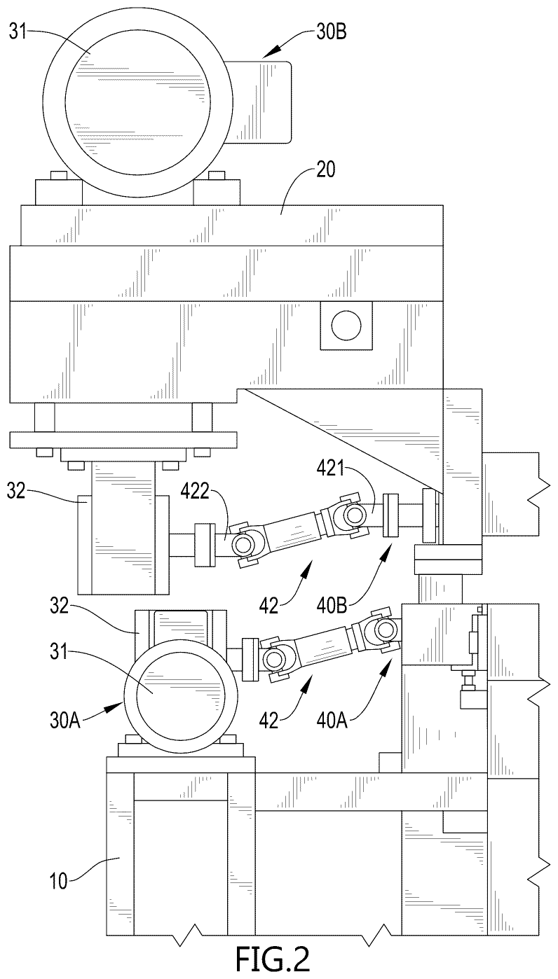

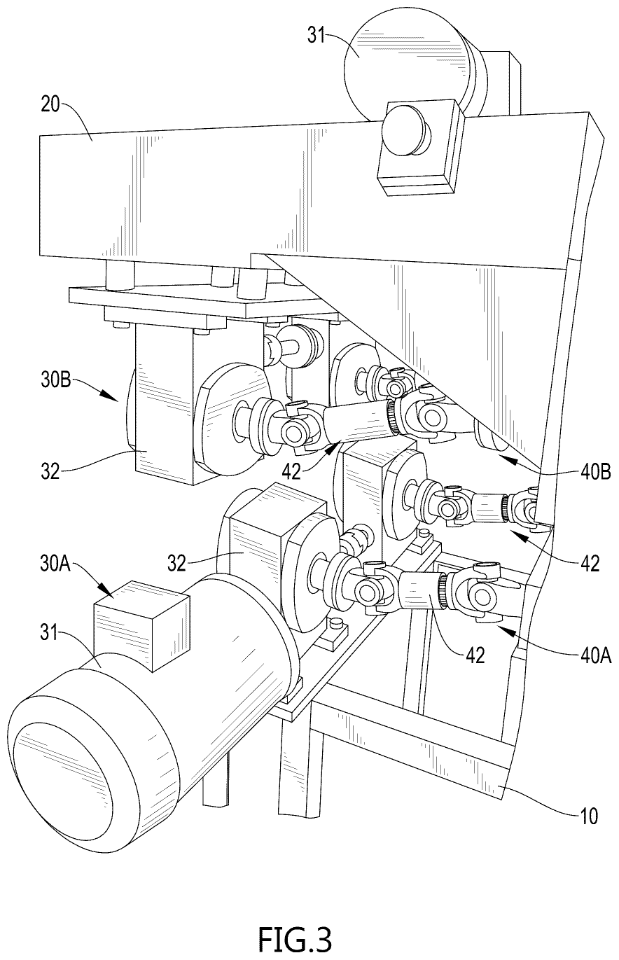

With reference to FIGS. 1 to 3 and 6, a wood planer in accordance with the present invention has a base 10, an elevating mount 20, two drive sets 30A, 30B, and two transfer devices 40A, 40B.

With reference to FIGS. 1 to 3, the base 10 is disposed at the bottom portion of the wood planer of the present invention and is configured to be deployed on the ground. The elevating mount 20 is disposed above the base 10 and can be driven by elevating devices (not shown) such as screw jacks or cylinders to move up and down relative to the base 10.

With reference to FIGS. 1 to 3, the two drive sets 30A, 30B are respectively disposed at the base 10 and the elevating mount 20. Each drive set 30A/30B has a motor 31 and a plurality of redirection devices 32 such as bevel gear boxes. The redirection devices 32 are connected in sequence via couplings, and one of the redirection devices 32 is connected to the motor 31.

With reference to FIGS. 1 to 3, the two transfer devices 40A, 40B are respectively disposed at the base 10 and the elevating mount 20. Wherein, the transfer device 40B disposed at the elevating mount 20 is able to move with the elevating mount 20 up and down relative to the base 10.

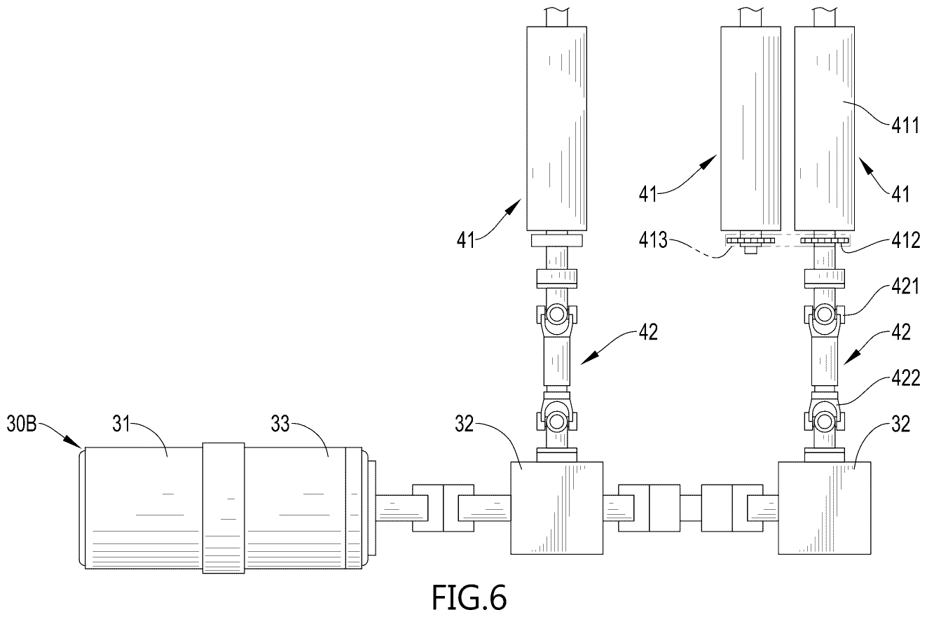

With reference to FIGS. 1 to 3 and 6, each of the two transfer devices 40A/40B includes a plurality of roller assemblies 41 and a plurality of universal joints 42. With reference to FIG. 6, each of the roller assemblies 41 has at least one roller 411. Each one of the universal joints 42 has an output end 421 and an input end 422 opposite in position. The output end 421 of each universal joint 42 is connected to a corresponding one of the at least one roller 411 and is configured to drive the corresponding one roller 411 to rotate. The input ends 422 of the universal joints 42 are respectively connected to the redirection devices 32, and the universal joints 42 can be driven by the motor 31 of a corresponding one of the drive sets 30A/30B.

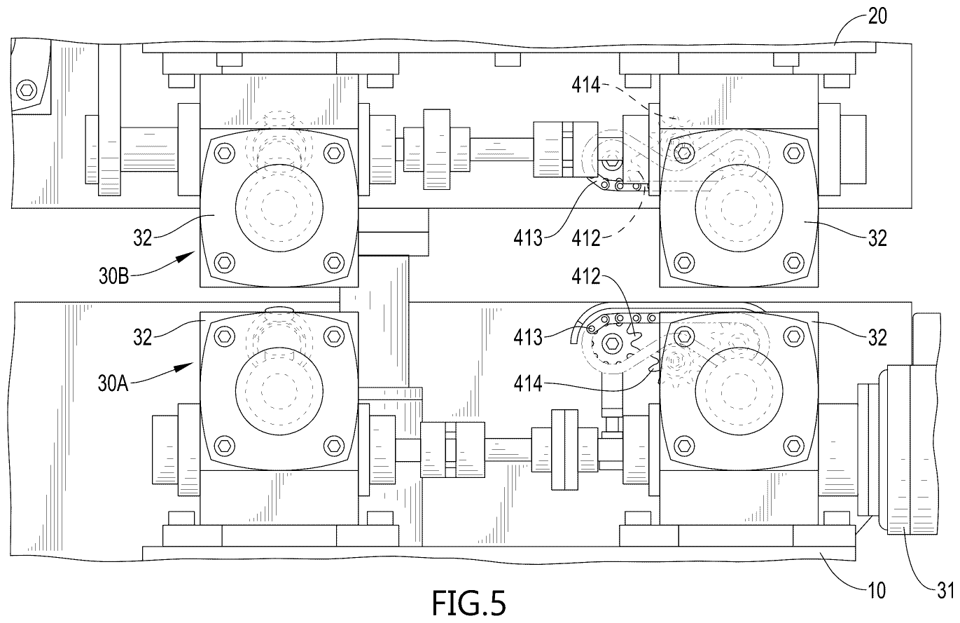

With reference to FIGS. 5 and 6, each roller assembly 41 may further have at least one driven component 412 connected to the at least one roller 411 of the roller assembly 41 respectively, each of the at least one driven component 412 is coaxially fixed to a corresponding one of the at least one roller 411 and is able to rotate simultaneously. Each driven component 412 may be a sprocket, a gear, a timing pulley, or a belt pulley. A transmit component 413 is wound around two adjacent said driven components 4123, and the transmit component 413 may be implemented as a chain, a timing belt, or a belt. Each roller assembly 41 may further have an idler wheel 414 to press the transmit component 413 of the roller assembly 41 to keep the tension of the transmit component 413.

Specifically, each drive set 30A/30B may further have a reducer 33 optionally. In FIG. 1, the reducer 33 is connected between the motor 31 and one of the redirection devices 32 of the drive set 30B, wherein the motor 31 and the reducer 33 are connected by a belt and belt pulleys. In FIG. 6, the motor 31 of the drive set 30B may be a servo motor and is directly connected to the reducer 33 implemented as a planetary gear reducer and is connected to the redirection device 32 via the reducer 33.

Practically, the reducer 33 may be implemented as a gear reducer, a planetary gear reducer, or a worm reducer. The type of the reducer 33 can be selected according to usage requirements.

Furthermore, each redirection device 32 of each drive set 30A/30B may be implemented as a worm redirector or a bevel redirector. As long as the output direction can be shifted, the type of the redirection device 32 is not restricted.

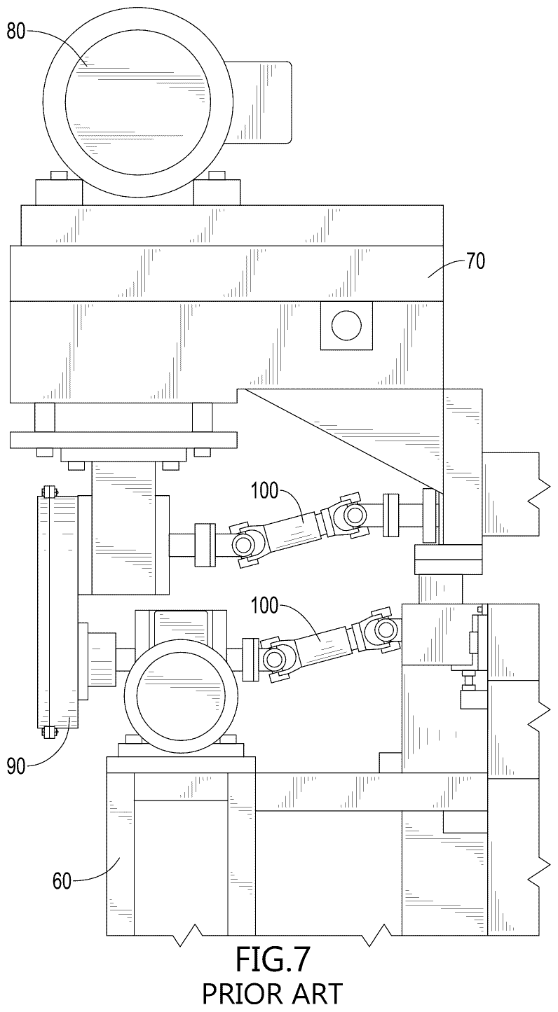

With reference to FIG. 7, the conventional double-sided wood planer is only powered by the sole motor 80 and transmits the power from the motor 80 via the transmitting device 90 with the worms and the worm gears to the universal joints 100. The universal joints 100 transmit the power to the transfer devices with the rollers. In the conventional double-sided wood planer, the sweeping range of each universal joint 100 is limited by the transmitting device 90. The thickness range of the woods configured to be planed by the conventional double-sided wood planer is restricted by the limited sweeping range of each universal joint 100 accordingly. Compared to the conventional double-sided wood planer, the wood planer in accordance with the present invention provides the two drive sets 30A, 30B respectively for powering the two transfer devices 40A, 40B. The elevating mount 20 can move relative to the base 10 without restriction. Consequently, the sweeping range of each universal joint 42 is not limited, and the thickness range of the wood to be planed is expanded.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A wood planer comprising:
a base disposed at a bottom of the wood planer to be deployed on a ground;
an elevating mount disposed above the base and configured to be driven to move up and down relative to the base;
two drive sets, each drive set having a motor and a plurality of redirection devices connected to the motor; and
two transfer devices respectively disposed at the base and the elevating mount, each one of the two transfer devices including
a plurality of roller assemblies, each roller assembly having at least one roller; and
a plurality of universal joints, each universal joint having an output end and an input end opposite in position;
the output end of each universal joint connected to one of the at least one roller of a corresponding one of the roller assemblies to power the roller to rotate;
the input end of each universal joint connected to a corresponding one of the redirection devices.

2. The wood planer as claimed in claim 1, wherein each drive set includes a reducer connected between the motor and the redirection devices of the drive set.

3. The wood planer as claimed in claim 2, wherein the reducer may be implemented as a gear reducer, a planetary gear reducer, and a worm reducer.

4. The wood planer as claimed in claim 3, wherein each redirection device may be implemented as a worm redirector or a bevel redirector.

5. The wood planer as claimed in claim 4, wherein
each roller assembly includes
at least one driven component connected to the at least one roller of the roller assembly respectively, and each driven component coaxially fixed to a corresponding one of the at least one roller of the roller assembly; and
a transmit component is wound around two adjacent said driven components.

6. The wood planer as claimed in claim 5, wherein each roller assembly includes an idler wheel to press the transmit component of the roller assembly.

7. The wood planer as claimed in claim 5, wherein
the driven component of each roller assembly is a sprocket; and
the transmit component wound around the driven component is a chain.

8. The wood planer as claimed in claim 5, wherein
the driven component of each roller assembly is a timing pulley; and
the transmit component wound around the driven component is a timing belt.

9. The wood planer as claimed in claim 5, wherein
the driven component of each roller assembly is a pulley; and
the transmit component wound around the driven component is a belt.

10. The wood planer as claimed in claim 1, wherein the two drive sets are respectively disposed at the base and the elevating mount.

11. The wood planer as claimed in claim 2, wherein the two drive sets are respectively disposed at the base and the elevating mount.

12. The wood planer as claimed in claim 3, wherein the two drive sets are respectively disposed at the base and the elevating mount.

13. The wood planer as claimed in claim 4, wherein the two drive sets are respectively disposed at the base and the elevating mount.

14. The wood planer as claimed in claim 5, wherein the two drive sets are respectively disposed at the base and the elevating mount.

15. The wood planer as claimed in claim 6, wherein the two drive sets are respectively disposed at the base and the elevating mount.

16. The wood planer as claimed in claim 7, wherein the two drive sets are respectively disposed at the base and the elevating mount.

17. The wood planer as claimed in claim 8, wherein the two drive sets are respectively disposed at the base and the elevating mount.

18. The wood planer as claimed in claim 9, wherein the two drive sets are respectively disposed at the base and the elevating mount.

19. The wood planer as claimed in claim 1, wherein each redirection device is a worm redirector or a bevel redirector.

20. The wood planer as claimed in claim 1, wherein each redirection device may be implemented as a worm redirector or a bevel redirector.
